(19) United States
(12) Patent Application Publication
(10) Pub. No.: US 2010/0214597 A1
(43) Pub. Date: Aug. 26, 2010

(54) SERVICE STATION

(76) Inventors: Kelvin Hasseler, Murrieta, CA (US); James Hasler, San Diego, CA (US); Yaguang Liu, San Diego, CA (US); Antoni Murcia, Poway, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/393,175

(22) Filed: Feb. 26, 2009

(51) Int. Cl. G06F 15/00; B41J 29/38

(52) U.S. Cl. 358/1.15; 347/5

(57) ABSTRACT

A service station for a print system includes a dedicated controller and a network interface configured to couple the service station to a central controller of the print system and to other components of the print system over a network. The dedicated controller is configured to allow the service station to perform a task in response to receiving a command indicative of the task over the network from the central controller of the print system without the central controller knowing the details of the task.

### BACKGROUND

Some inkjet printers, such as industrial inkjet printers, may be used for high-throughput applications, such as printing forms, advertisements, lottery tickets, etc. The manufacture of some industrial inkjet printers may involve a manufacturer integrating components from one or more vendors to form a single industrial inkjet printer. For example, the manufacturer may integrate, a printer maintenance system e.g., often called a service station, an ink management system, a print-head management system, a recording-media (e.g., paper) management system, etc. from one or more vendors to produce an industrial inkjet printer. The manufacturer may then control these systems with a controller that manages, for example, the overall inkjet system and image processing.

### DESCRIPTION OF THE DRAWINGS

FIG. 1 is a block diagram of an imaging system, according to an embodiment.

FIG. 2 is a block diagram of an embodiment of a service station, according to another embodiment.

FIG. 3 illustrates a print head, according to another embodiment.

FIG. 4 is a flowchart of an example of an algorithm performed by a service station, according to another embodiment.

FIG. 5 is a flowchart of an example of an algorithm performed by a central controller of a print system, according to another embodiment.

### DETAILED DESCRIPTION

In the following detailed description of the present embodiments, reference is made to the accompanying drawings that form a part hereof, and in which are shown by way of illustration specific embodiments that may be practiced. These embodiments are described in sufficient detail to enable those skilled in the art to practice disclosed subject matter, and it is to be understood that other embodiments may be utilized and that process, electrical or mechanical changes may be made without departing from the scope of the claimed subject matter. The following detailed description is, therefore, not to be taken in a limiting sense, and the scope of the claimed subject matter is defined only by the appended claims and equivalents thereof.

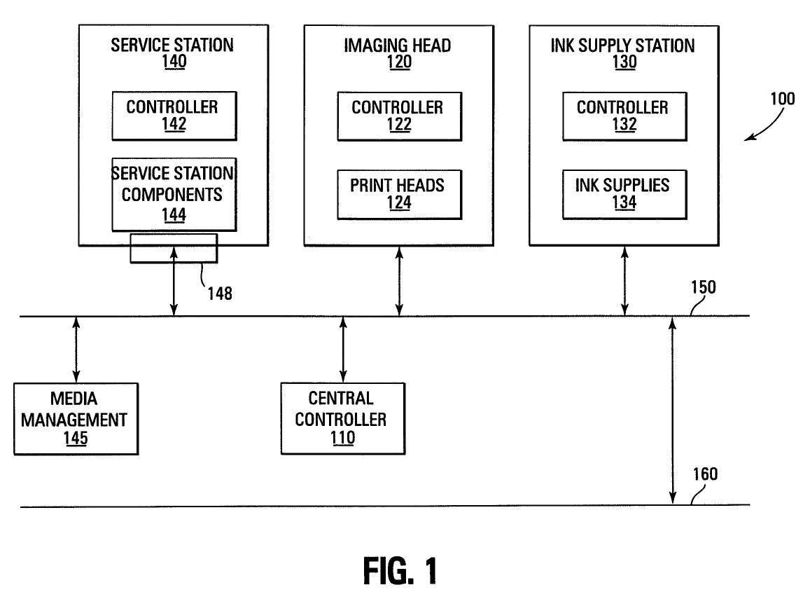

FIG. 1 is a block diagram of an imaging system, such as an inkjet print system 100. For an embodiment, inkjet print system 100 may be an industrial inkjet printer. Print system 100 has a central print system controller 110, such as a master controller, configured to control the overall operation of print system 100. Central controller 110 manages print system 100 and performs image processing to convert images into print-head- (e.g., pen-) ready bits. Central controller 110 may further manage handling of recording media, such as a printable media, e.g., paper.

Print system 100 incorporates a modular design and may include an imaging head (e.g., a pen driver) module 120, an ink supply station (e.g., an ink management) module 130, a print head (e.g., pen) service station module 140, and a media management module 145, such as a paper management module. Central controller 110 may be coupled to imaging-head module 120, ink supply station module 130, print head service station module 140, and media management module 145 over a network 150, such as a local area network (LAN), that may be coupled to the Internet 160. As such commands and data (e.g., in the form of electrical signals) are sent and received over network 150.

For example, central controller 110 may be coupled to imaging-head module 120, ink supply station module 130, print head service station module 140, and media management module 145 over an Ethernet interface via RJ 45 connectors. Alternatively, controller 110 may be coupled to imaging-head module 120, ink supply station module 130, print head service station module 140, and media management module 145 using an RS 232 interface using RS 232 connectors.

For one embodiment, central controller 110 and media management module 145 may be designed by a manufacturer of print system 100, and imaging head module 120, ink supply station module 130, and print head service station module 140 may be provided by one or more outside vendors. As such, the manufacturer of print system 100 may be a customer of these vendors.

Imaging head module 120 includes a dedicated controller 122 that is configured to allow imaging head module 120 to perform various methods in response to commands from central controller 110. Imaging head module 120 also includes print heads (e.g., pens) 124. For example print heads 124 may be thermal inkjet print heads, impulse (e.g., piezoelectric) inkjet print heads, electro-spray print heads, continuous jet print heads, acoustic jet print heads, or the like.

Ink supply station module 130 includes a dedicated controller 132 that is configured to allow ink supply station module 130 to perform various methods in response to commands from central controller 110. Ink supply station module 130 also includes ink supplies 134, such as ink reservoirs.

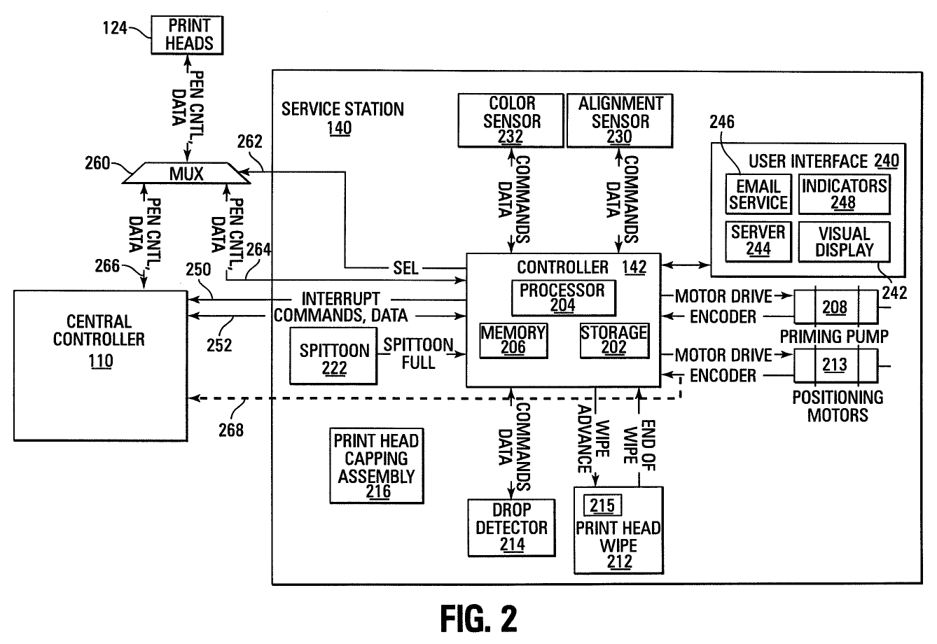

Service station module 140 includes a dedicated controller 142 and service station components 144. Controller 142 may include a storage device 202, such as a hard drive, removable flash memory, etc. and a processor 204 for processing computer-readable instructions, as shown in FIG. 2, a detailed block diagram of service station module 140. These computer-readable instructions are stored in a memory 206, such as a computer-usable medium, and may be in the form of software, firmware, hardware, or a combination thereof. The computer-readable instructions configure controller 142 to allow service station module 140 to perform various methods, such as described below in conjunction with various disclosed embodiments.

In a hardware solution, the computer-readable instructions are hard coded as part of processor 204, e.g., an application-specific integrated circuit (ASIC) chip, a field programmable gate array (FPGA), etc. In a software or firmware solution, the instructions are stored for retrieval by the processor 204. Some additional examples of computer-usable media include static or dynamic random access memory (SRAM or DRAM), read-only memory (ROM), electrically erasable programmable ROM (EEPROM or flash memory), magnetic media and optical media, whether permanent or removable. Most consumer-oriented computer applications are software solutions provided to the user on some form of removable computer-usable media, such as a compact disc read-only memory (CD-ROM) or digital video disc (DVD).

Referring to FIG. 2, service station 140 may include a print head (e.g., a pen) priming pump 208 (e.g., as part of service station components 144) that is configured to suction (e.g., vacuum) prime print heads 124 in response to receiving commands, such as motor drive commands, (e.g., in the form of electrical signals) from controller 142. For example, pen priming pump 208 may operate in the suction mode when suction priming print heads 124. Pen priming pump 208 receives the motor drive commands from controller 142 for driving motors, such as servo motors, of pump 208. Pen priming pump 208 may include an encoder for sending information (e.g., in the form of electrical signals) to controller 142 about the movement of the motor of pump 208.

Service station also includes a print head (e.g., a pen) wiper 212 (e.g., as part of service station components 144) that is configured to wipe print heads 124 in response to receiving commands from controller 142. Print head wiper 212 may be modular and replaceable by an end user. For one embodiment, print head wiper 212 includes a wiping medium, such as cloth, paper, etc., that is advanced in response to commands (e.g., in the form of electrical signals) from controller 142. Print head wiper 212 may be further configured to sense when the wiping medium is exhausted and to send a signal to controller 142 indicating that the wiping medium is exhausted, e.g., needs replacement. The wiping medium may be contained in a removable, replaceable cartridge.

Wiper 212 may be further configured to add different wiping fluids, e.g., hydroscopic wiping fluids, to the wiping medium based on the type of ink ejected from a print head 124 and/or the type of paper being printed on. The wiping fluids act to help the wiping medium to better clean the print heads. Print head wiper 212 may be further configured to sense when the wiping fluid is exhausted and to send a signal to controller 142 indicating that the wiping fluid is exhausted, e.g., needs replacement.

Wiper 212 may include a storage device 215, such as a nonvolatile storage device, e.g., an EPROM or an EEPROM. For example, storage device 215 may be part of the removable, replaceable cartridge. Storage device 215 may be configured to store information about wiper 212. For example, storage device 215 may include information about the age of the wiping medium and/or how much of the wiping medium remains, information about the types of ink being wiped using the wiping medium, information about the types of wiping fluids and how much wiping fluid remains, etc. The information that is stored on storage device 215 may be sent, e.g., in the form of electrical signals, to storage device 215 from controller 142. Information about how much of the wiping medium remains may be indicated by displaying how much of the wiping medium remains using an icon in the form of a gauge on a display of storage device 215. In addition, some information about wiper 212 that is stored in storage device 215 may be information added by the manufacturer, such as when wiper 212 was manufactured, the type of wiping medium, how much wiping medium, etc.

Positioning motors 213 (e.g., as part of service station components 144), such as servomotors, may move print heads 124 to print head wiper 212, e.g., in response to receiving motor drive commands (e.g., in the form of electrical signals) from controller 142 as part of controller 142 executing a print head wiping algorithm. Alternatively, positioning motors 213 may move print head wiper 212 to print heads 124, e.g., in response to receiving the motor drive commands from controller 142 as part of controller 142 executing the print head wiping algorithm. Positioning motors 213 may include an encoder that sends information (e.g., in the form of electrical signals) to controller 142 regarding the movement of positioning motors 213.

Service station 140 may further include a drop detector 214 (e.g., as part of service station components 144). Drop detector 214 is configured to determine the health of the nozzles of print heads 124, e.g., whether drops are being ejected from the nozzles of print heads 124, drop size, drop velocity, etc., in response to receiving commands from controller 142 (e.g., in the form of electrical signals). Drop detector 214 is further configured to provide data (e.g., in the form of electrical signals) to controller 142, indicating the health of the nozzles of print heads 124.

Drop detector 214 may be an optical detector that includes a light source that is directed at paths that the drops take after being ejected from the nozzles of print heads 124. Drop detector 214 may further include a light sensor for capturing light scattered from the ink drops or for detecting shadows cast by the ink drops.

For another embodiment, drop detector 214 may be an electrostatic drop detector configured to induce a charge on drops as they are ejected from nozzles of print heads 124. For example, drop detector 214 may have a sense plate, amplifier, and a metal “can.” The metal “can” is biased to a high voltage (e.g., about 120 VDC) and has a slot that runs parallel to the nozzle columns of the print heads. The slot functions to provide both an electrostatic field to charge the drops and as a shield to protect the sense plate from ambient electrical noise. During operation, drops are fired through the slot and substantially parallel to the sense plate. Charge neutrality requires that the charge on the sense plate match the charge on the drops.

Positioning motors 213 may move print heads 124 to drop detector 214, e.g., in response to receiving motor drive commands from controller 142 as part of controller 142 executing a drop detection or a nozzle health determination algorithm. Alternatively, positioning motors 213 may move drop detector 214 to print heads 124, e.g., in response to receiving the motor drive commands from controller 142 as part of controller 142 executing the drop detection or the nozzle health determination algorithm. The motion imparted by positioning motors is coordinated with the firing of the nozzles, drop detector 122, and the nozzle health determination algorithm to determine whether every nozzle is functioning.

Service station 140 may further include a print head (e.g., pen) capping assembly 216 (e.g., as part of service station components 144) that is configured to cap the nozzles of print heads 124 when print heads 124 are not being used. For example, capping assembly 216 may include caps that cap the nozzles. Positioning motors 213 may move print heads 124 to capping assembly 216, e.g., in response to receiving motor drive commands from controller 142 as part of controller 142 executing a print head capping algorithm. Alternatively, positioning motors 213 may move capping assembly 216 to print heads 124, e.g., in response to receiving the motor drive commands from controller 142 as part of controller 142 executing the pen capping algorithm.

For another embodiment, capping assembly 216 may be configured to facilitate suction priming of a print head 124 in conjunction with suction provided by priming pump 208. For example, capping assembly 216 may include a coupler that when positioned over a print head 124, fluidly couples the nozzles to the suction of priming pump 208. The suction prime is implemented to remove dried ink from the nozzles of print heads 124 as part of controller 142 executing a print head priming algorithm.

Service station 140 may further include a spittoon 222 (e.g., as part of service station components 144). Positioning motors 213 may move print heads 124 to spittoon 222, e.g., in response to receiving motor drive commands from controller 142 as part of controller 142 executing a print head spitting algorithm, where print heads 124 eject (e.g., spit) ink into spittoon 222. Alternatively, positioning motors 213 may move spittoon 222 to print heads 124, e.g., in response to receiving the motor drive commands from controller 142 as part of controller 142 executing the print head spitting algorithm. Note that print heads 124 may eject ink into spittoon 222 during a drop detection algorithm, where drop detector is used to determine whether drops are being ejected from the nozzles of print heads 124, to determine drop size, to determine drop velocity, etc. as ink drops are ejected into spittoon 222.

For one embodiment, spittoon 222 may include a sensor for sensing the amount of ink ejected into spittoon 222. When spittoon 222 is full, the sensor may send an electrical signal to controller 142, indicating that spittoon 222 is full.

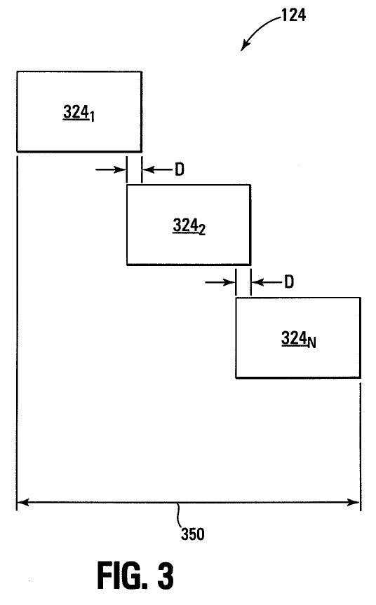

Service station 140 may also include a print head alignment sensor 230 (e.g., as part of service station components 144). For one embodiment, print system 100 may use two or more print heads, such as print heads 324₁ to 324_{N}, to span a certain width 350 to form a print head 124 for printing a swath of the certain width 350, as shown in FIG. 3. In the event that one or more of the print heads 324 is replaced, print head alignment sensor 230 is used to determine whether the one or more replaced print heads 324 aligns with the print heads that are not replaced. For another embodiment, print heads 324 may be staggered so that they overlap each other by a distance D, as shown in FIG. 3. In this embodiment, print head alignment sensor 230 may be used to set the overlap distance D.

Print head alignment sensor 230 may be configured to determine print-head alignment in response to receiving commands (e.g., in the form of electrical signals) from controller 142. Print head alignment sensor 230 may be configured to send data (e.g., in the form of electrical signals) to controller 142 indicative of print-head alignment.

Positioning motors 213 may move print heads 124 to print head alignment sensor 230, e.g., in response to receiving motor drive commands from controller 142 as part of controller 142 executing a print head alignment algorithm. Alternatively, positioning motors 213 may move alignment sensor 230 to print heads 124, e.g., in response to receiving the motor drive commands from controller 142 as part of controller 142 executing the print head alignment algorithm.

A suitable alignment sensor, according to one embodiment, may include one or more light sources, such as LEDs. For example, there may be light sources that can emit light wavelengths corresponding to red, green, blue, and orange. The light sources project the light onto the paper as the paper moves beneath the print heads and as the print heads are ejecting ink drops onto the paper. Light striking the paper and any ink drops deposited on the paper is reflected onto one or more light detectors that convert the reflected light received thereat to electrical signals, such as voltage or current signals. For example, a diffuse component of the reflected light provides information as to the presence of ink drops on the paper. Controller 142 receives the electrical signals from the alignment sensor and determines that an ink drop is present when the electrical signal has a certain magnitude (e.g., a certain voltage or current level).

For one embodiment, print head alignment is determined by determining the actual time at which an ink drop strikes the paper and comparing the actual time to an expected time at which the drop would strike the paper for a properly aligned print head. For example, the alignment sensor senses that the ink drop strikes the paper, and controller 142 determines the actual time at which the ink-drop strike occurs in response to receiving an electrical signal from the alignment sensor indicative of the ink-drop strike. When the difference between expected time and the actual time is less than or equal to a certain numerical value, controller 142 determines that the print head is properly aligned. When the difference between expected time and the actual time is greater than the certain numerical value, controller 142 determines that the print head is not properly aligned.

Note that the time difference corresponds to a distance on the paper as the paper moves past alignment sensor from an expected location to the actual measured location. That is, the difference in location, based on a paper path encoder signal from the media management station 145 and a print head firing signal from imaging-head module 120, is the actual distance to be corrected and is converted into a time. The time difference will be used to increase or delay the drop firing in firing algorithms of the imaging-head module 120.

Service station 140 may further include a color sensor 232 (e.g., as part of service station components 144) configured to sense colors printed on the paper. Color sensor 232 may be configured to sense the colors in response to receiving commands (e.g., in the form of electrical signals) from controller 142. Color sensor 232 may be configured to send data (e.g., in the form of electrical signals) to controller 142 indicative of the sensed colors. Positioning motors 213 may position color sensor 232 over portions of the paper, e.g., in response to receiving motor drive commands from controller 142 as part of controller 142 executing a color sensing algorithm.

Color sensor 232 may use different wavelengths of visible light (via the use of LEDs or some other fixed wavelength source) to illuminate images printed on paper and measuring the amount of reflectance for each of those wavelengths. Alternatively, a “white” light can be used in combination with different wavelength filters.

Color sensor 232 may be scanned over printed images on the paper to obtain information that can be used for a variety of things, such as Pantone color matching (developed by Pantone, Inc., Carlstadt, N.J., USA) and/or color calibration. There may be a feedback loop where the scan results can be used to adjust the color maps of the printer in order to match a predefined color palette. The scans can be used to determine color consistency from printed page to printed page.

Service station 140 may also include a dedicated user interface 240 (e.g., as part of service station components 144) configured to provide information to users, e.g., regarding the status of service station 140. For example, user interface 240 might indicate that spittoon 222 is full and requires maintenance (e.g., needs to be emptied), the wiping medium of print head wiper 212 is exhausted and requires maintenance (e.g., needs replacement), a part of one or more of the service station components 144 needs maintenance or is worn out and needs replacement.

User interface 240 may include a visual display 242 (e.g., an LCD display or the like), a server 244 (e.g., a personal computer or the like), email service 244, and/or indicators 248. For one embodiment, server 244 and email service 246 may be coupled to the Internet 160 (FIG. 1), e.g., via network 150. Server 244 may be accessible in the form of a website on the Internet 160 hosted by server 244. Controller 142 may send information regarding the status of service station 140 to server 244 for display on the website. The information might also be displayed on visual display 242.

Alternatively, controller 142 may send information regarding the status of service station 140 to email service 246, and email service 246 may send this information to users in the form of an email message. The users' email addresses may be stored in storage device 202.

Indicators 248 may be visual indicators, such as LEDS, and/or audible indicators, such as buzzers. An indicator 248 might indicate the status of service station 140 or of the status a service station component 144.

User interface 240 may further include an input device (not shown), such as a keyboard. The input device can be used to input user email addresses for storage in storage device 202, commands regarding the operation of service station 140, or responses to errors or alarms, e.g. indicated by indicators 248, email service 246, and/or server 244. Alternatively, visual display 242 may be configured for receiving inputs. For example, visual display 242 may be touch-sensitive. For another embodiment, commands regarding the operation of service station 140 or responses to errors or alarms may be input to server 244 via the website hosted by server 244.

For one embodiment, controller 142 might maintain log files, e.g., in storage device 202, that include the status of service station 140, such as in the form of maintenance information, errors, usage tracking, item wear, etc. Controller 142 may also-be configured to perform a fully integrated self-diagnostic for purposes of determining the status of service station 140, without input from, e.g., independently of, central controller 110. For example, the self-diagnostic might determine whether spittoon 222 is full, whether the wiping medium is exhausted, and/or whether there are any active errors. The self-diagnostic might determine the usage of (the number of operating hours on) and/or the wear of service station components 144 or components of service station components 144.

For servo debug purposes, controller 142 might provide and store, e.g., in storage device 202, information about the servo variables with margin and error information about each servo state. For example, the status of service station 140 may include the status of the servo variables, including the margin and error information about each servo state, such as acceptable errors for print head alignment. For one embodiment, controller may be configured to send the status of service station 140 stored in storage device 202 in the form maintenance information (e.g., maintenance performed and maintenance needed to be performed), errors, usage tracking, item wear, servo variables, etc. to user interface 240 for display on visual display 242 and/or on the website hosted by server 244. Email service 246 might also email the status to various users.

For one embodiment, controller 142, and thus service station 140, is coupled to central controller 110, imaging-head module 120, ink supply station module 130, and media management station 145 through a network interface 148 (FIG. 1), such as an Ethernet Interface, via a network connector, such as an RJ 45 connector or an RS 232 connector, or the like. Controller 142 communicates with central controller 110 over network 150 using interrupt signals via an interrupt channel 250 provided by network interface 148 and via command and data channels 252 network interface 148, as shown in FIG. 2.

Controller 142, and thus service station 140, may be selectively coupled to print heads 124 through a multiplexer 260 that is controlled by the controller 142 via select signals over a select line 262. The select signals cause multiplexer 260 to switch between a first operating mode and a second operating mode. For example, multiplexer 260 may switch to the first operating mode in response to receiving one select signal and to the second operating mode in response to another select signal.

In the first operating mode, multiplexer 260 permits control and data signals to be sent from controller 142 to print heads 124 via control/data lines 264 for controlling print heads 124 while controller 142 executes steps (e.g., the steps of spitting, drop detection, print head capping, etc.) of a servicing algorithm. For example, print heads 124 are driven by controller 142 as needed for servicing.

In the second operating mode, multiplexer 260 permits control and data signals to be sent from central controller 110 to print heads 124 via control/data lines 266. This allows print heads 124 to be controlled, e.g., driven, by central controller 110, as needed for servicing, while controller 142 performs the steps of the servicing algorithm (e.g., the steps of spitting, drop detection, print head capping, etc.).

In particular, central controller 110 instructs the main pen drive electronics to fire the print heads 124 in synch with movements of service station 140, e.g., during drop detection and/or print head alignment, by monitoring the encoders of positioning motors 213 via signals received at central controller 110 from the encoders over signal line 268. This approach requires the involvement of controller 110 to set up the printing image for the servicing routine (drop detection, print head alignment, etc.), but no intervention from central controller 110 would be required, as the encoder and pen drive electronics could handle the rest without central controller 110.

Service station 140 may handle all the low-level details of the hardware and the various servicing procedures. This allows central controller 110 to just send high-level commands, such as general, standardized commands, to the controller 142, and then be free to perform other functions while servicing proceeds. For example, controller 142 may be configured to execute steps of a task, such as servicing algorithm, in response to receiving a command from central controller 110 that instructs controller 142 to execute the algorithm without central controller 110 knowing the detailed steps of the algorithm.

Controller 142 thus provides an abstraction layer so that central controller 110 does not need detailed knowledge of the inner workings of service station 140. This enables controller 142 to be compatible with the central controllers of a number different print systems and backward compatible with existing systems. Further, the abstraction layer protects the details the of inner workings of service station 140 and its algorithms from being disclosed to the manufacturer of print system 100 and controller 110 in the event that the manufacturer of print system 100 and controller 110 and the supplier of service station 140 are different entities.

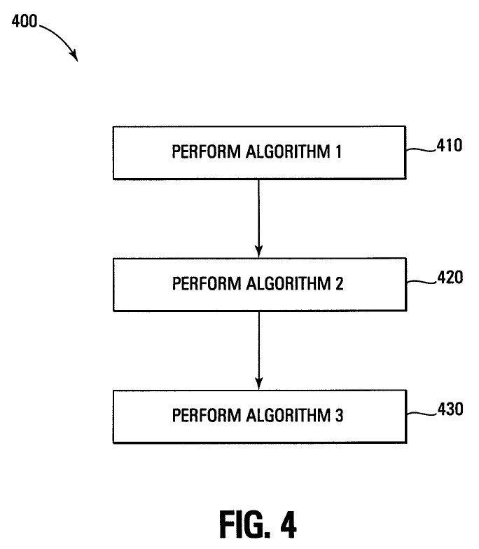

For one embodiment, controller 142 may be configured to receive a higher level command from central controller 110 and to perform an algorithm in response to that higher level command without central controller 110 being aware of the details algorithm. For example, central controller 110 may send a higher level command that instructs controller 142 to execute an algorithm 400 that includes executing algorithm 1 at block 410, algorithm 2 at block 420, and algorithm 3 at block 430, as shown in the flowchart of FIG. 4. That is, central controller 110 has no knowledge of algorithm 400 and does not execute algorithm 400.

For example, the higher level command may be sent in response to central controller 110 requesting service station 140 to perform a higher level task, such as performing a pen recovery or a mid-print job service. Algorithms 1, 2, and 3 may be steps of algorithm 400 that remain unknown to central controller 110. For example, algorithm 1 might be a suction prime step of the pen recovery or a mid-print job service that suction primes print heads 124, algorithm 2 a drop detection step of the pen recovery or a mid-print job service, and algorithm 3 a capping step of the pen recovery or a mid-print job service that caps print heads 124.

For one embodiment, controller 142 may be further configured to receive a lower-level command from central controller 110 in response to central controller 110 performing each step of an algorithm. Controller 142 may perform detailed steps in response to each lower level command without central controller being aware of the detailed steps.

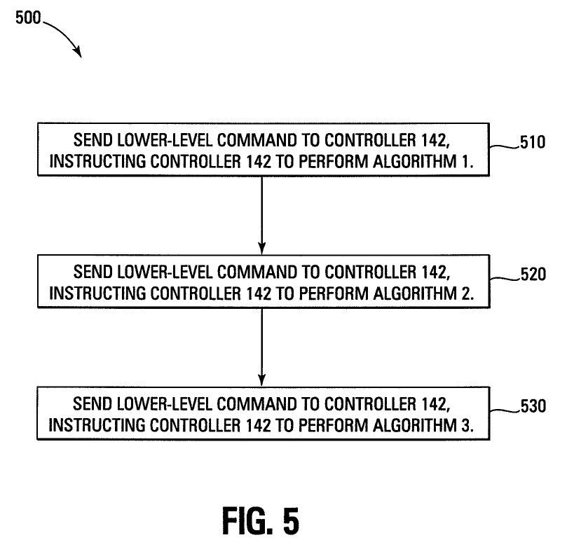

For example, central controller 110 may execute algorithm 500, as shown in the flowchart of FIG. 5. Performing step 510 involves central controller 110 sending a lower level command to controller 142 that instructs controller 142 to perform the specific steps of algorithm 1 without central controller 110 knowing what the specific steps of algorithm 1 are. For example, algorithm 1 may perform the suction prime step of the pen recovery or the mid-print job service that suction primes print heads 124.

After completing algorithm 1, controller 142 indicates to central controller 110 that algorithm 1 is completed. In response to receiving this indication, central controller 110 performs step 520 that involves sending another lower level command to controller 142 that instructs controller 142 to perform the specific steps of algorithm 2 without central controller 110 knowing what the specific steps of algorithm 2 are. For example, algorithm 2 may perform the drop detection step of the pen recovery or the mid-print job service.

After completing algorithm 2, controller 142 indicates to central controller 110 that algorithm 2 is completed. In response to receiving this indication, central controller 110 performs step 530 that involves sending another lower level command to controller 142 that instructs controller 142 to perform the specific steps of algorithm 3 without central controller 110 knowing what the specific steps of algorithm 3 are. For example, algorithm 3 may perform the capping step of the pen recovery or the mid-print job service that caps print heads 124.

In view of the foregoing, it is apparent that controller 142 is configurable to handle different levels of commands from central controller 110 and to perform different levels of tasks.

For one embodiment, suction priming may involve service station 140 positioning capping assembly 216 over print heads 124 so that the nozzles are fluidly coupled to priming pump 208 and driving the motors of priming pump 208 to suction prime print heads 124. Next, select line 262 to multiplexer 260 is asserted so that the service station 140 can drive print heads 124, and drop detector 214 is positioned under print heads 124. Drop detection is then performed by service station 140 coordinating the firing of nozzles, performing the required movements, and collecting and processing the drop detection data. Service station 140 then performs the movements required to position capping assembly 216 so that the caps thereof cap print heads 124, asserts an interrupt to the printing system controller signaling that the task is complete, and delivers the nozzle health information to central controller 110.

When events occur in service station 140, such as the spittoon is full, a print head is out of alignment, or a wipe cartridge is used up, that require notification of the status of service station 140 to the user or user intervention, service station 140 asserts an interrupt to the central controller 110 so that service station 140 can notify the user, via email, the website hosted by server 244, visual display 242, and/or indicators 248, to take appropriate action. In this way, central controller 110 does not have to spend time polling for the occurrence of such events. Note that central controller 110 does not need to have detailed knowledge of the various event sensors, such as spittoon full, wipe cartridge used up, etc., in service station 140.

Some advantages of a service station having a dedicated controller and being configurable to handle different levels of commands and to perform different levels of tasks include the central controller being able to service print heads without knowing the details of the servicing algorithms. In current systems, the central controller controls the details of print head servicing and requires that the central controller have intimate knowledge of service station operation. This uses up processing resources of the central controller that could otherwise be used for tasks during servicing. Using a service station responsive to high-level commands from the central controller acts to remedy this problem so that the central controller can perform other tasks while servicing proceeds.

Another advantage is that the service station 140 is responsive general, standardized commands from the central controller, meaning that the central controller does not need to control the low-level, detailed operation of the service station. This acts to make service station 140 more easily compatible with the central controllers of different modular printing systems. The fact service station 140 is responsive general, standardized commands enables service station 140 to be backward compatible with existing print systems so that these systems can be easily retrofit to include service station 140.

In addition, the central controller does not need to know the specific details of the servicing routines or algorithms and thus these details are prevented from being disclosed to the manufacturer of the print system and the central controller in the event that the vendor who provides the service station and manufacturer of the print system and the central controller are different entities.

### CONCLUSION

Although specific embodiments have been illustrated and described herein it is manifestly intended that the scope of the claimed subject matter be limited only by the following claims and equivalents thereof.

What is claimed is:

1. A service station for a print system, comprising:
a dedicated controller; and
a network interface configured to couple the service station to a central controller of the print system and to other components of the print system over a network;
wherein the dedicated controller is configured to allow the service station to perform a task in response to receiving a command indicative of the task over the network from the central controller of the print system without the central controller knowing the details of the task.

2. The service station of claim 1, further comprising a dedicated user interface coupled to the dedicated controller.

3. The service station of claim 1, further comprising a print head wiper coupled to the dedicated controller and comprising a storage device configured to receive information from the dedicated controller.

4. The service station of claim 1, further comprising at least one of an email service coupled to the dedicated controller and coupleable to the Internet and a server coupled to the dedicated controller and coupleable to the Internet.

5. The service station of claim 1, further comprising a print head capping assembly configured to couple nozzles of print heads of the print system to suction of a pump for suction priming the print heads.

6. The service station of claim 1, further comprising at least one of a color sensor coupled to the dedicated controller and a print head alignment sensor coupled to the dedicated controller.

7. The service station of claim 1, wherein the network interface is an Ethernet interface.

8. The service station of claim 1, wherein the dedicated controller and the central controller are selectively coupled to print heads of the print system through a multiplexer that is controlled by the dedicated controller, wherein the multiplexer is configured to allow the service station to control the print heads of the print system through the multiplexer in response to receiving a signal from the dedicated controller, wherein the multiplexer is further configured to allow the central controller to control the print heads of the print system through the multiplexer in response to receiving another signal from the dedicated controller.

9. The service station of claim 1, wherein the dedicated controller is configured to perform a self-diagnostic independently of the central controller.

10. A method of operating a service station of a print system, comprising:
receiving a command from a central controller of the print system over a network, instructing the service station to perform an algorithm; and
performing steps of the algorithm at the service station in response to the command without the central controller of the print system knowing what the steps of the algorithm are.

11. The method of claim 10, further comprising sending a signal to a multiplexer that causes the multiplexer to allow the service station to control the print heads of the print system through the multiplexer while performing the steps of the algorithm.

12. The method of claim 10, further comprising sending a signal to the multiplexer that causes the multiplexer to allow the central controller to control the print heads of the print system through the multiplexer while the service station performs the steps of the algorithm.

13. A method of operating a service station of a print system, comprising:
determining a status of the service station; and
emailing the status of the service station to user or sending the status to a website on the Internet;
wherein the service station is coupled to other components of the print system over a network.

14. The method of claim 13, further comprising storing the status of the service station at the service station.

15. The method of claim 13, wherein the status of the service station includes maintenance information, error information, usage information, and/or wear information.
